(19) United States
(12) Patent Application Publication
(10) Pub. No.: US 2011/0059721 A1
(43) Pub. Date: Mar. 10, 2011

(54) METHOD OF HANDLING EMERGENCY-PURPOSED SHORT MESSAGE SERVICE IN A WIRELESS COMMUNICATION SYSTEM AND RELATED APPARATUS

(76) Inventor: Te-Ming Chen, Taoyuan County (TW)

(21) Appl. No.: 12/876,248

(22) Filed: Sep. 7, 2010

Related U.S. Application Data
(60) Provisional application No. 61/241,037, filed on Sep. 10, 2009.

(51) Int. Cl. H04W 4/22

(52) U.S. Cl. 455/404.2; 455/404.1

(57) ABSTRACT

A method of handling emergency-purposed short message service (SMS) message is for a mobile device in a wireless communication system. The method comprises generating an emergency SMS message; and transmitting the emergency SMS message to a SMS message center of a network of the wireless communication system according to a first priority class corresponding to connection establishment for the emergency SMS message.

### CROSS REFERENCE TO RELATED APPLICATIONS

This application claims the benefit of U.S. Provisional Application No. 61/241,037, field on Sep. 10, 2009 and entitled “Supporting Emergency SMS Message” the contents of which are incorporated herein in their entirety.

### BACKGROUND OF THE INVENTION

1. Field of the Invention

A method utilized in a wireless communication and apparatus thereof is disclosed, and more particularly to a method of handling emergency-purposed short message service (SMS) in a wireless communication system and related apparatus.

2. Description of the Prior Art

Short message service (SMS) is a technology for transmitting and receiving text messages between mobile devices. In the beginning, the SMS was introduced in the Global System for Mobile Communications (GSM) standard by the European Telecommunications Standards Institute (ETSI). The 3rd Generation Partnership Project (3GPP) standardizes and maintains the GSM and SMS standards. Generally, the SMS message can support most languages around the world and easily be exchanged between different radio access technologies (RATS).

In order to transfer the SMS message, an SMS center (SMSC) plays the role to handle the SMS operations. When a mobile device transmits an SMS to the wireless network, an SMSC in the wireless network receives the SMS message and then forwards the SMS message to the destination mobile device. Before the destination mobile device receives the SMS message, the SMS message may be passed through more than one network entity (e.g. SMSC and SMS gateway). If the destination mobile device is unavailable (e.g. offline), the SMSC can store the SMS message temporarily until the SMS can be forwarded to the destination mobile device successfully. Because the SMS message mainly transmits text content, it wastes less radio resources of the wireless network compared with making a voice call. Therefore, it is an economic way for saving cost and the radio resources.

More and more serious disaster occurred everywhere, such as earthquake, tsunami and so on. In this situation, all people suffering from serious disasters may use their mobile devices to dial out for emergency calls to the emergency center to ask for help. Because of too many emergency call setup requests at the same time, all radio resources of the base station are consumed. If connection establishment for the emergency calls are failed, people may try to re-dial, thereby causing radio resources fully occupied again. Further, even though the mobile device obtains the radio resources and connects to the emergency center successfully, the emergency center may not be provided with enough human resources to process those requests at the same time. Therefore, how to solve out of radio resources when a large amount of emergency calls are made at the same period (during a short period) is a topic for discussion.

### SUMMARY OF THE INVENTION

A method and related device for handling emergency-purposed short message service (SMS) in a wireless communication system is disclosed.

A method of handling emergency-purposed short message service (SMS) for a mobile device in a wireless communication system is disclosed. The method comprises generating an emergency SMS message; and transmitting the emergency SMS message to a SMS message center of a network of the wireless communication system according to a first priority class corresponding to connection establishment for the emergency SMS message.

A method of handling emergency-purposed short message service (SMS) for a network in a wireless communication system is disclosed. The method comprises receiving an emergency SMS message; and receiving the emergency SMS message to a SMS message center of a network of the wireless communication system according to a first priority class corresponding to connection establishment for the emergency SMS message.

A communication device of a wireless communication system for handling emergency-purposed short message service (SMS) is disclosed. The communication device comprises means for generating an emergency SMS message; and means for transmitting the emergency SMS message to a SMS message center of a network of the wireless communication system according to a first priority class corresponding to connection establishment for the emergency SMS message.

These and other objectives of the present disclosure will no doubt become obvious to those of ordinary skill in the art after reading the following detailed description of the preferred example that is illustrated in the various figures and drawings.

### BRIEF DESCRIPTION OF THE DRAWINGS

FIG. 1 is a schematic diagram of an exemplary wireless communication system.

FIG. 2 is a schematic diagram of an exemplary communication device.

FIG. 3 and FIG. 4 are flowcharts of exemplary processes for handling emergency-purposed short message service (SMS) message.

### DETAILED DESCRIPTION

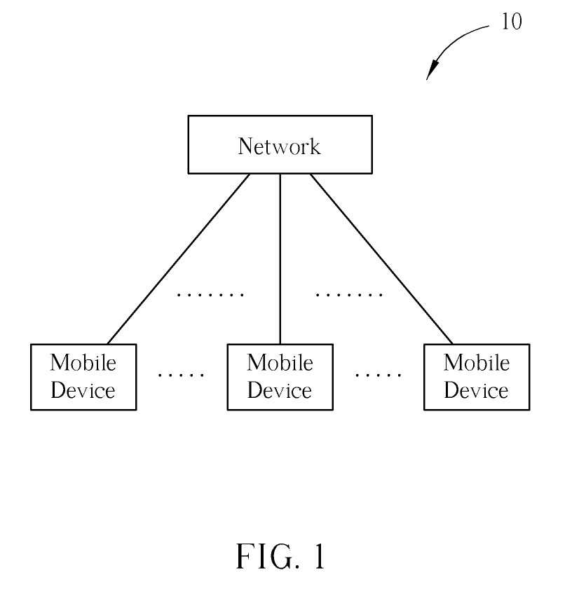

Please refer to FIG. 1, which illustrates a schematic diagram of an exemplary wireless communication system 10. Briefly, the wireless communication system 10 includes a network and a plurality of mobile devices. In FIG. 1, the network and the mobile devices are simply utilized for illustrating the structure of the wireless communication system 10. The wireless communication system 10 supports a short message service (SMS) and maybe a second generation (2G) wireless communication system (e.g. Global System for Mobile (GSM) communications system), a 3G wireless communication system (e.g. Universal Mobile Telecommunications System (UMTS) communications system), or a beyond 3G wireless communication system (e.g. long term evolution (LTE) communications system). In the GSM system, the network is referred as a GERAN (GSM/EDEG Radio Access Network) comprising a plurality of base stations, whereas the mobile devices are referred as mobile stations (MSs). In the UMTS system, the network is referred as a UTRAN (universal terrestrial radio access network) comprising a plurality of NBs (Node-Bs), whereas the mobile devices are referred as to user equipments (UEs). In the LTE system, the network is referred as an E-UTRAN (evolved-UTRAN) comprising a plurality of eNBs (evolved NBs) controlling cells and a core network entity (e.g. Mobility Management Entity), whereas the mobile devices are referred as to user equipments (UEs). The mobile devices can be devices such as mobile phones, computer systems, etc. Besides, the network and the MS can be seen as a transmitter or receiver according to transmission direction, e.g., for uplink (UL), the MS is the transmitter and the network is the receiver, and for downlink (DL), the network is the transmitter and the MS is the receiver.

Before transmitting a SMS message, a UE should establish a connection to the network with an establishment cause. The UE can use several establishment causes corresponding to a priority sequence that from high to low may include priority classes “emergency”, “highPriorityAccess”, “mt-Access”, “mo-Signalling”, and “mo-Data”. According to the priority class of the establishment causes sent by the UE, the network can know which connection data should be processed first and which connection data can be postponed to be processed. In other words, the network prioritizes radio resource assignment for the connections according to the priority classes of the connections. For example, the UE uses the priority class “emergency” to establish a connection with network, and then the UE can get radio resources as soon as possible because the priority class “emergency” is the highest priority class in the abovementioned example. When the UE transmits a normal SMS message (non-emergency SMS message), the UE may use the priority class “mo-Data” to establish a connection with network. In this situation, the UE obtains radio resources for transmission of the normal SMS message from the network after the network has processed other requests from other UEs whose priority classes are higher than the priority class “mo-Data”.

An SMS center (SMSC) as a network entity utilizes for receiving SMS messages transmitted from the origination mobile device and then forwarding the SMS messages to the destination mobile device. Because the destination mobile device has a specific number, the origination mobile device can reach the destination mobile device by the specific number when transmitting a SMS message. Types of SMS messages may include emergency SMS messages and non-emergency SMS messages (e.g. normal SMS messages). The network may also include an emergency center for handling emergency calls and emergency SMS messages.

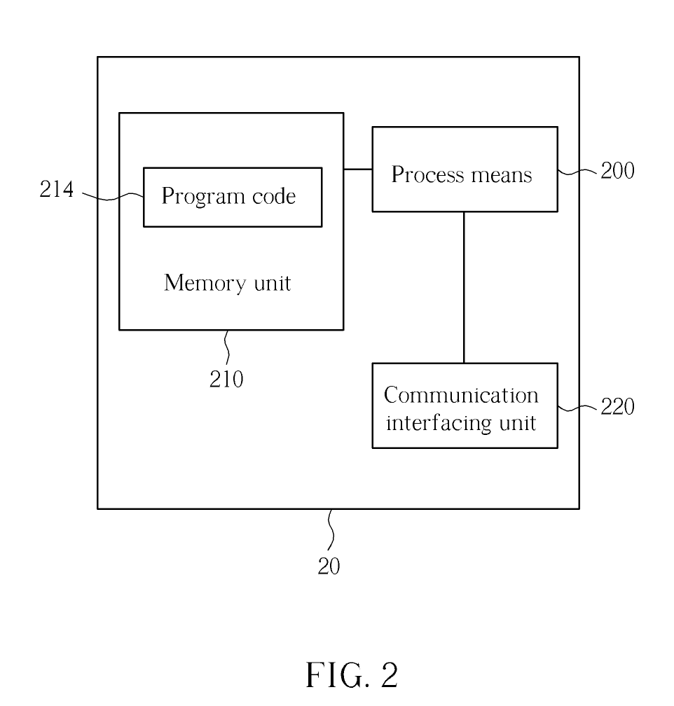

FIG. 2 illustrates a schematic diagram of an exemplary communication device 20. The communication device 20 can be the mobile device or the network shown in FIG. 1. The communication device 20 may include a processing means 200 such as a microprocessor or Application Specific Integrated Circuit (ASIC), a memory unit 210 and a communication interfacing unit 220. The memory unit 210 may be any data storage device that can store program code 214, for access by the processing means 200. Examples of the memory unit 210 include but are not limited to a subscriber identity module (SIM), read-only memory (ROM), random-access memory (RAM), CD-ROMs, magnetic tapes, hard disks, and optical data storage devices. The communication interfacing unit 220 is preferably a radio transceiver and can exchange wireless signals with the network according to processing results of the processing means 200.

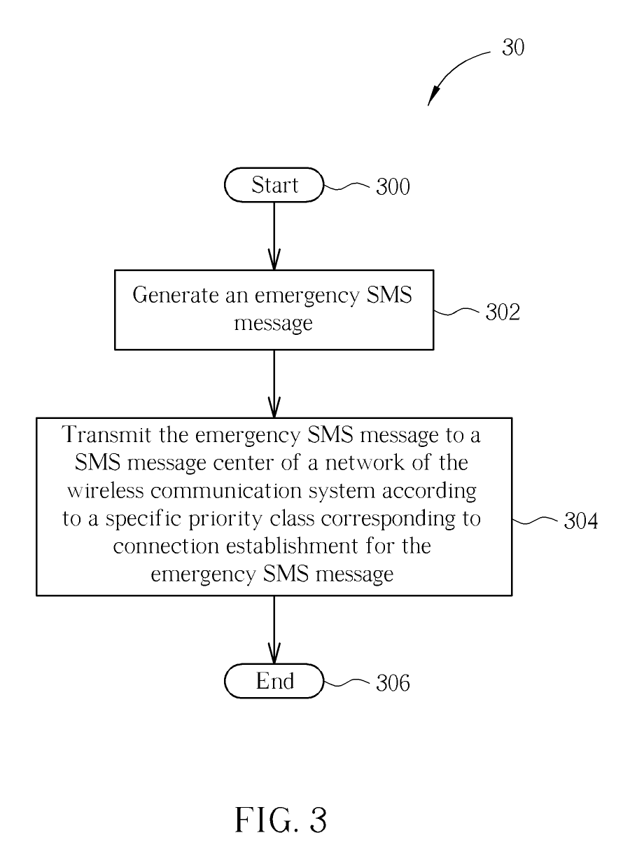

Please refer to FIG. 3, which is a flowchart of an exemplary process 30. The process 30 is used for handling emergency-purposed SMS message for a UE in a wireless communication system. The process 30 may be compiled into the program code 214 and includes the following steps:

Step 300: Start.

Step 302: Generate an emergency SMS message.

Step 304: Transmit the emergency SMS message to a SMS message center of a network of the wireless communication system according to a specific priority class corresponding to connection establishment for the emergency SMS message.

Step 306: End.

According to the process 30, the UE generates the emergency SMS message and then establishes the connection for the emergency SMS message with the network to transmit the emergency SMS message to an SMS message center of the network. Before an SMS message to the wireless network is transmitted, a priority class “mo-Data” may be used for establishing a connection with the network. The priority class “mo-Data” is a lower priority than signaling and emergency call as abovementioned, and the UE obtains radio resources from the network after finishing other higher priority request. Thus, a specific priority class is introduced for emergency SMS message, thereby allowing the UE to obtain radio resources as soon as possible. The UE determines that the SMS message is an emergency SMS message, when a number of the termination mobile device for receiving the SMS message is an emergency number. The UE determines that the number of the termination mobile device is an emergency number which is depended on the emergency number stored by the UE, stored by the SIM/USIM, or downloaded by the serving network when the SIM/USIM is present. Further, the UE may be allowed to transmit the emergency SMS message without SIM/USIM present.

Alternatively, a user can set an input via a user interface of the UE to indicate a generated SMS message is an emergency SMS message. By doing so, the user can decide whether the emergency SMS message can be transmitted to the destination mobile device (e.g. a friend's UE) other than the emergency center. Further, the UE regards the SMS message as an emergency SMS message and transmits the emergency SMS message to the SMS message center according to a specific priority class corresponding to connection establishment.

In order to obtain radio resources as soon as possible for the emergency SMS message, the specific priority class can be set as the priority class “emergency” used by the emergency call, or be higher than the priority class “emergency”, or be lower than the priority class “emergency” and higher than other existing priority classes. Further, an emergency SMS message may also include geographic location information to inform the network of the location of the mobile device.

Please note that, for normal SMS purpose, the network should activate integrity protection to use security mode control procedure to transmit an SMS message and integrity protection of all SMS signaling messages is the responsibility of lower layers, e.g. media access control (MAC) layers. However, for an emergency purpose, an emergency SMS may be established without integrity protection. In addition, the network may be a network excluding an Internet protocol multimedia core network subsystem.

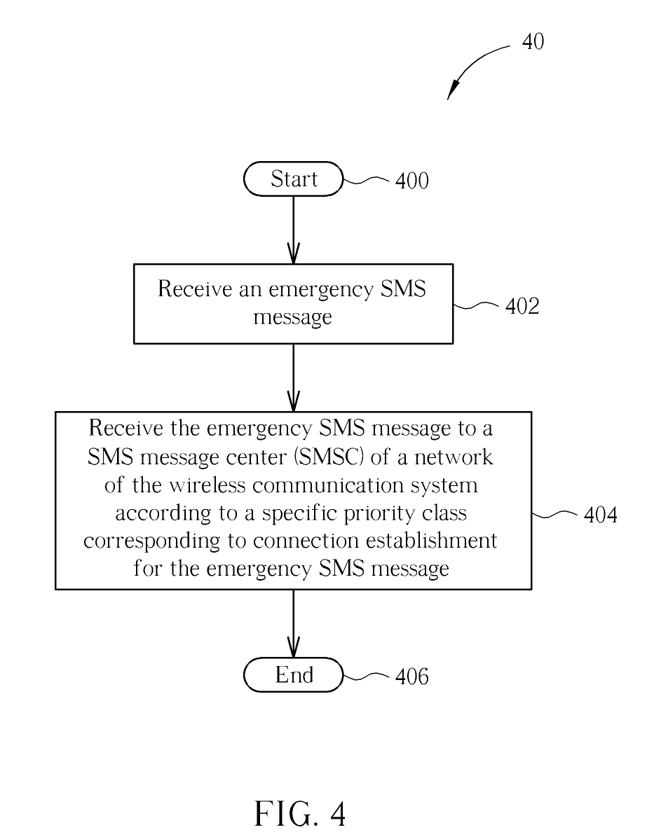

Please refer to FIG. 4, which is a flowchart of a process 40 according to an example. The process 40 is used for handling emergency-purposed SMS for a network in a wireless communication system. The process 40 may be compiled into the program code 214 and include the following steps:

Step 400: Start.

Step 402: receive an emergency SMS message.

Step 404: receive the emergency SMS message to a SMS message center (SMSC) of a network of the wireless communication system according to a specific priority class corresponding to connection establishment for the emergency SMS message.

Step 406: End.

According to the process 40, the network may support to establish a connection for the emergency SMS according to a specific priority class with the UE. Further, for the normal SMS message according to the priority class “mo-Data”, the SMSC erases the normal SMS message after forwarding the normal SMS message to the destination mobile device. However, the importance of the emergency SMS message is more than the importance of the normal SMS message, thus, the SMSC may record all emergency SMS messages to provide the emergency center with enough information to process the emergency requests. Further, the SMSC may process the emergency SMS messages first and then other types of SMS messages, in order not to delay the emergency request.

Because the SMS message wastes less radio resources of the network compared with making a voice call, when the serious disasters happens and all radio resources are occupied by emergency calls, the emergency SMS message can be utilized for asking help with less radio resources. Further, the emergency center processes the emergency requests included in the emergency SMS message after receiving the emergency SMS message. Because the SMSC keeps all emergency SMS messages, the emergency center can also check the emergency SMS message in the SMSC in order not to ignore the emergency request if the UE fails to send the emergency SMS message to the emergency center.

Please note that, the abovementioned steps of the processes including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20.

In conclusion, some of the examples as mentioned above provide ways of how to handle emergency-purposed SMS message so that the UE can transmit emergency-purposed SMS message as soon as possible. In addition, some of the examples provide ways of how to process corresponding emergency-purposed SMS message as soon as possible in the SMSC.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A method of handling emergency-purposed short message service (SMS) for a mobile device in a wireless communication system, the method comprising:
generating an emergency SMS message; and
transmitting the emergency SMS message to a SMS message center of a network of the wireless communication system according to a first priority class corresponding to connection establishment for the emergency SMS message.

2. The method of claim 1, wherein generating the emergency SMS message comprises:
determining that a generated SMS message is the emergency SMS message, when a terminated number of the generated SMS message is an emergency number; or
determining that the generated SMS message is the emergency SMS message, according to an input signal of an user interface unit of the mobile device.

3. The method of claim 1, wherein the mobile device further includes a second priority class corresponding to connection establishment for an emergency call and a plurality of priority classes corresponding to connection establishments for services other than the emergency call and the emergency SMS message, and the method of claim 1 further comprising:
setting the first priority class to be the second priority class; or
setting the first priority class to be higher than the second priority class, wherein the second priority class is set higher than the plurality of priority classes; or
setting the first priority class to be lower than the second priority class and higher than the plurality of priority classes.

4. The method of claim 1, wherein transmitting the emergency SMS message to the SMS message center of the network of the wireless communication system according to the first priority class corresponding to the connection establishment for the emergency SMS message comprises:
transmitting the emergency SMS message to the SMS message center according to the first priority class without integrity protection.

5. The method of claim 1, wherein the network excludes an internet protocol multimedia core network subsystem.

6. The method of claim 1 further comprising:
including geographic location information in the emergency SMS message.

7. A method of handling emergency-purposed short message service (SMS) for a network in a wireless communication system, the method comprising:
receiving an emergency SMS message; and
receiving the emergency SMS message to a SMS message center of a network of the wireless communication system according to a first priority class corresponding to connection establishment for the emergency SMS message.

8. The method of claim 7, wherein the network excludes an internet protocol multimedia core network subsystem.

9. The method of claim 7 further comprising:
recording all emergency SMS messages in the SMS message center.

10. The method of claim 7 further comprising:
processing the emergency SMS messages first and then other SMS messages in the SMS message center.

11. A communication device of a wireless communication system for handling emergency-purposed short message service (SMS), the communication device comprising:
means for generating an emergency SMS message; and
means for transmitting the emergency SMS message to a SMS message center of a network of the wireless communication system according to a first priority class corresponding to connection establishment for the emergency SMS message.

12. The communication device of claim 11, wherein the means for generating the emergency SMS message comprises:
means for determining that a generated SMS message is the emergency SMS message, when a terminated number of the generated SMS message is an emergency number; or
means for determining that the generated SMS message is the emergency SMS message, according to an input signal of an user interface unit of the mobile device.

13. The communication device of claim 11, wherein the communication device further includes a second priority class corresponding to connection establishment for an emergency call and a plurality of priority classes corresponding to connection establishments for services other than the emergency call and the emergency SMS message, and the communication device of claim 11 further comprising:
means for setting the first priority class to be the second priority class; or
means for setting the first priority class to be higher than the second priority class, wherein the second priority class is set higher than the plurality of priority classes; or
means for setting the first priority class to be lower than the second priority class and higher than the plurality of priority classes.

14. The communication device of claim 11, wherein the means, for transmitting the emergency SMS message to the SMS message center of the network of the wireless communication system according to the first priority class corresponding to the connection establishment for the emergency SMS message, transmits the emergency SMS message to the SMS message center according to the first priority class without integrity protection.

15. The communication device of claim 11, wherein the network excludes an internet protocol multimedia core network subsystem.

16. The communication device of claim 11 further comprising:
means for including geographic location information in the emergency SMS message.
